(19) United States
(12) Patent Application Publication
(10) Pub. No.: US 2009/0244475 A1
(43) Pub. Date: Oct. 1, 2009

(54) Amphibious Glasses and Temple Assembly for Use in Eyeglasses

(75) Inventor: Chih-Cheng Shiue, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: QBAS CO., LTD., Taipei (TW)

(21) Appl. No.: 12/411,555

(22) Filed: Mar. 26, 2009

(30) Foreign Application Priority Data
Mar. 28, 2008 (TW) 97205366

(51) Int. Cl. G02C 11/00; G02C 5/14

(52) U.S. Cl. 351/43; 351/123

(57) ABSTRACT

A pair of amphibious glasses is provided. The pair of amphibious glasses comprises a lens assembly, a frame assembly, a skirt, and a temple assembly. The lens assembly comprises at least one lens, while the frame assembly defines at least one frame so that the lens can be embedded into the frame. The skirt is detachably attached to one side of the frame assembly and extends outward from the side of the frame assembly. The skirt is adapted to fit against the face around the eyes of the user. The temple assembly is adapted so that the pair of amphibious glasses can firmly fit on the user's face.

This application claims the benefit of priority based on Taiwan Patent Application No. 097205366 filed on Mar. 28, 2008, the disclosure of which is incorporated herein by reference in its entirety.

### CROSS-REFERENCES TO RELATED APPLICATIONS

Not applicable.

### BACKGROUND OF THE INVENTION

1. Field of the Invention

The present invention relates to a pair of amphibious glasses, and more particularly, to a pair of amphibious glasses having a special temple design.

2. Descriptions of the Related Art

Eyeglasses may be worn for different reasons. For example, eyeglasses may be worn for vision correction or for shielding intensive sunlight. In addition, with the widespread popularity of various recreational sports, eyeglasses have been tailored to fit different needs and functions. Examples include eyeglasses used for water sports such as surfing, diving and swimming or land sports such as ball games and car racing.

For example, swimming goggles prevent water from coming into contact with the user's eyes during various water sports, thereby protecting the eyes against infections and injuries. A general outline view of a conventional swimming goggle 1 is shown in FIG. 1, which is a schematic perspective view of the conventional swimming goggle 1. The conventional swimming goggle 1 comprises a frame 11, a pair of lenses 12, a skirt 13, an adjustment buckle 14 and a hair band 15. In further reference to FIG. 2, a schematic perspective view of a pair of conventional eyeglasses 2 is shown therein. The pair of eyeglasses 2 is used for land sports, and comprises a frame 21, lenses 22 and temples 23.

Currently, if users would like to participate in both a water and land sport, both eyeglasses 2 and swimming goggles 1 must be readily available. When one or the other is not in use, it will have to be properly stored. Consequently, switching between the two pairs of glasses and properly storing them can be inconvenient.

Accordingly, it is important to develop a pair of amphibious glasses incorporating functions of both swimming goggles and land-use eyeglasses.

### SUMMARY OF THE INVENTION

One objective of this invention is to provide a pair of amphibious glasses that is easy to detach and assemble to overcome the shortcomings of the prior art. When worn in the water by the user, the pair of amphibious glasses is adapted to fit firmly against the user's face around the eyes to prevent incursion of water into the eyes, thereby facilitating free movement in the water. On the other hand, when worn on land by the user, the pair of amphibious glasses is adapted to function as a pair of common eyeglasses to shield off the wind and rain and protect the eyes.

This invention provides a pair of amphibious glasses, comprising a lens assembly, a frame assembly, a skirt, and a temple assembly. The lens assembly includes at least one lens. The frame assembly defines at least one frame so that the at least one lens can be embedded into the at least one frame. The skirt, which is detachably attached to one side of the frame assembly and extends outward from the side of the frame assembly, is adapted to fit against the user's face around the user's eyes. The temple assembly includes two temples and two fasteners. The first end portions of the temples are disposed respectively on the two end portions of the frame assembly. The fasteners are respectively disposed on the second end portions of the temples opposite the first end portion so that the pair of amphibious glasses fit firmly on the user's face.

Also, this invention provides a temple assembly for use in a pair of eyeglasses. The pair of eyeglasses includes a main body. The temple assembly is connected to the two corresponding end portions of the main body. The temple assembly comprises two temples and two fasteners. Each of the temples has a first and second end portion. The two first end portions are disposed respectively on the two corresponding end portions of the main body of the frame assembly. The two fasteners are disposed respectively on the second end portions of the two temples, so that the pair of eyeglasses can firmly fit on the user's face.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic perspective view of a conventional swimming goggle;

FIG. 2 is a schematic perspective view of a pair of conventional eyeglasses for land use;

FIG. 3A is a schematic perspective view of a pair of amphibious glasses in an embodiment of this invention;

FIG. 3B is a schematic cross-sectional view of the pair of amphibious glasses shown in FIG. 3A;

FIG. 4A is a schematic perspective view of a temple assembly in an embodiment of this invention;

FIG. 4B is a schematic perspective view of a temple assembly in an embodiment of this invention;

FIG. 4C is a schematic perspective view of a temple assembly in an embodiment of this invention;

FIG. 4D is a schematic perspective view of a temple assembly in an embodiment of this invention; and

FIG. 4E is a schematic perspective view of a temple assembly in an embodiment of this invention.

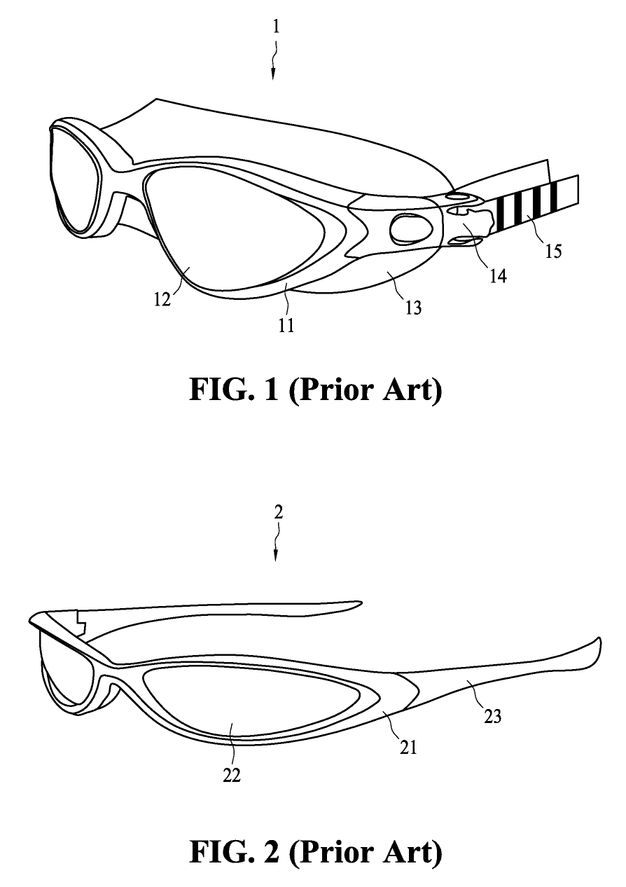

### DESCRIPTION OF THE PREFERRED EMBODIMENT

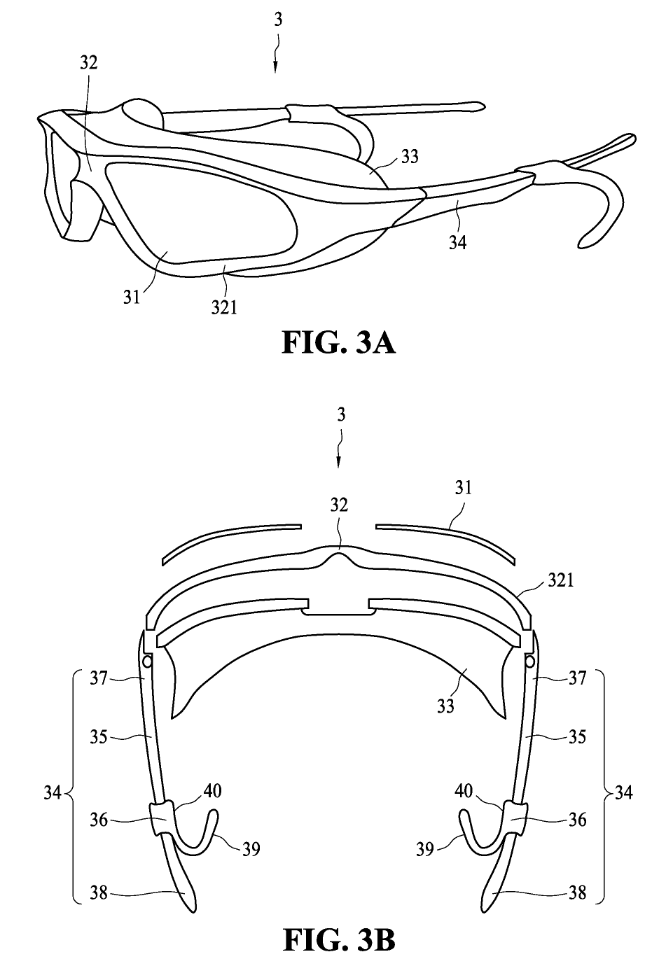

A schematic structure and cross-sectional view of an embodiment of this invention are shown in FIGS. 3A and 3B respectively. The pair of amphibious glasses 3 comprises a lens assembly 31, a frame assembly 32, a skirt 33 and a temple assembly 34. The lens assembly 31 comprises at least one lens. In this embodiment, the lens assembly 31 comprises two lenses, although this invention is not limited thereto. On the other hand, the frame assembly 32 has a body adapted to straddle the user's dorsum nasi. The frame assembly 32 also defines at least one frame 321 depending on the number of lenses actually included in the lens assembly so that the lens of the lens assembly 31 can be embedded into the frame 321 tightly. Furthermore, the skirt 33, which is detachably disposed on one side of the frame assembly 32 and extends outward from the side of the frame assembly, is adapted to tightly fit against the user's face (not shown) around the user's eyes. The temple assembly 34 allows the pair of amphibious glasses 3 to firmly fix onto the user's face.

The following descriptions are made in reference to both FIGS. 3A and 3B. This invention is characterized in that the skirt 33 has a deformable soft portion. In the preferred embodiment, the soft portion is made of materials selected from a group consisting of thermoplastic rubber (TPR), thermoplastic polyurethane (TPU), thermoplastic elastomer (TPE), polyurethane (PU), polyvinylchloride (PVC), silicone and combinations thereof. The soft skirt 33 is not only adapted to tightly fit against the user's face when the user is engaged in a water sport, but also helps to shield off the wind and protect the user's eyes when the user is engaged in a land sport.

It should be particularly noted that the aforesaid temple assembly 34 comprises two temples 35 and two fasteners 36. Each of the temples 35 has a first end portion 37 and a second end portion 38. The first end portions 37 of the two temples 35 are disposed respectively on the two corresponding end portions of the main body of the frame assembly 32. In this embodiment, the first end portions 37 are pivotally disposed on the frame assembly 32 respectively, although this invention is not limited thereto. On the other hand, the two fasteners 36 are disposed respectively on the second end portions 38 of the two temples 35, so that the two temples 35 can allow the pair of amphibious glasses 3 to firmly fit across the user's dorsum nasi.

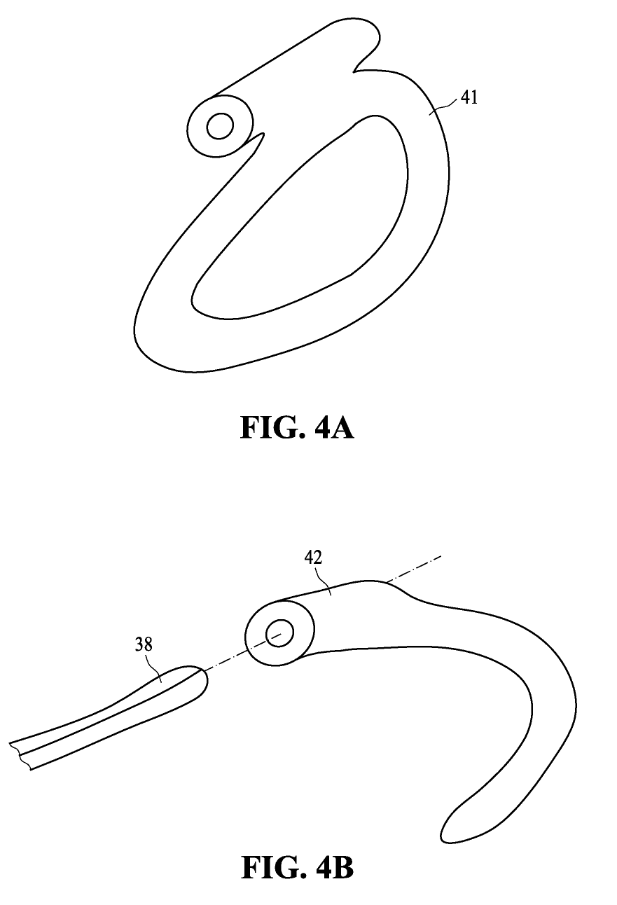

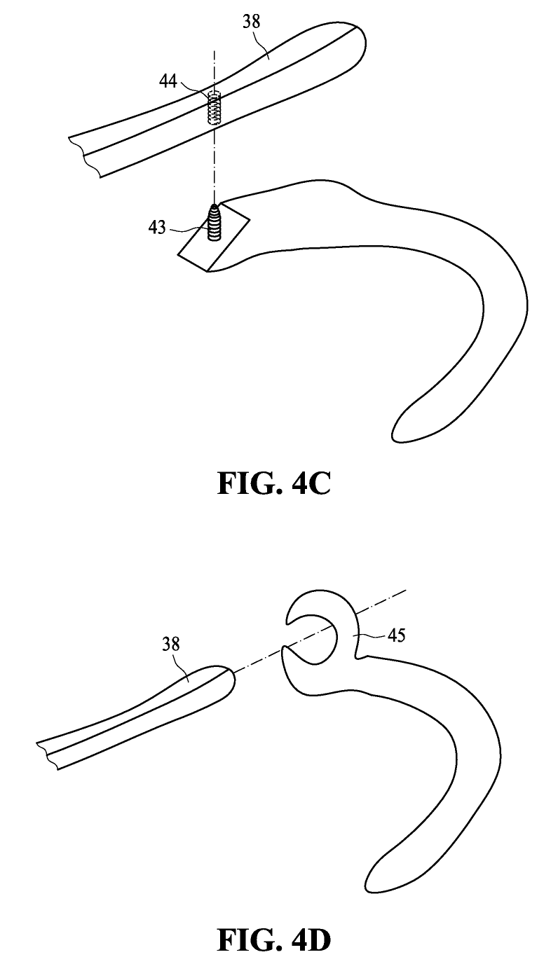

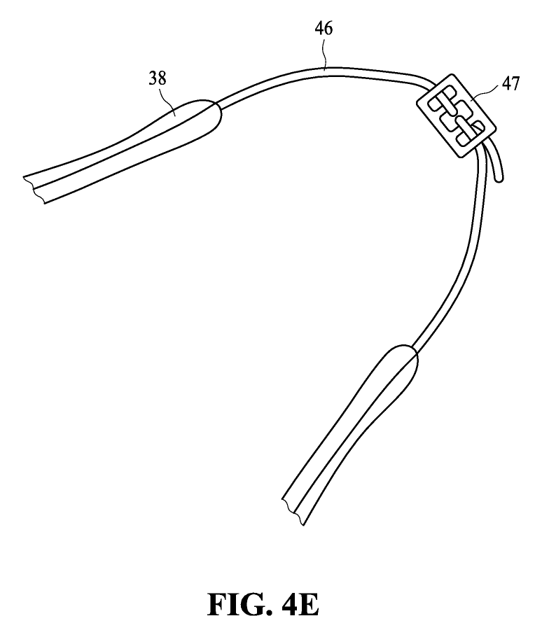

More specifically, to enhance the fastening of the pair of amphibious glasses 3 of this invention in use, each of the fasteners 36 of the temple assembly 34 has a hook structure 39 and a joint structure 40. The hook structures 39 are adapted to fit against the user's ears so that the two temples 35 can firmly sit on the user's ears. It should be noted that the hook structures 39 are only provided as an exemplary example. In other embodiments as shown in FIG. 4A, each of the hook structures 39 may also be replaced by a ring structure 41, which is adapted to circle around the user's ear for auxiliary fastening.

In this invention, the fasteners 36 and the temples 35 can be joined in a variety of methods. Possible examples of the joint structure 40 will be described in detail hereinafter with reference to several embodiments thereof. The first kind is a detachable joint structure, by which the fasteners 36 are detachably disposed on the second end portions 38 of the temples 35. This kind of joint structure 40 may be implemented by several means. In particular, referring to FIG. 4B, an embodiment of the joint structure 40 is a tube 42 which is adapted to be detachably sleeve the second end portion 38 of each of the temples 35. In detail, the tube 42 is made of an elastomer which may be made of an elastic material such as rubber, so that the tube 42 is adapted to slide along the second end portion of the respective temple 35 to change its position. This facilitates the adjustment of the distance between the fasteners 36 and the frame assembly 32 depending on personal needs, thereby strengthening the auxiliary fastening function of the fasteners 36.

In reference to FIG. 4C, in this embodiment, the joint structure 40 is a protruded screw 43, and each of the temples 35 comprises a corresponding screw hole 44 at the second end portion 38. The protruded screw 43 is adapted to be screwed into the screw hole so that the fastener 36 is fixed to the temple 35.

In addition, in reference to FIG. 4D, in this embodiment, the joint structure 40 is a clip 45 which may be made of a hard material such as plastic. The clip 45 is adapted to detachably clip to the second end portion of each of the temples 35 and change its position on each of the temples 35, so that the user can slidably adjust a distance between the fastener 36 and the frame assembly 32.

Next, in reference to FIG. 4E, each of the fasteners is a ring belt 46, which is disposed on the second end portion 38 of each of the temples and adapted to circle the user's head. The ring belt 46 further comprises an adjustment piece 47 adapted to allow the user to adjust the tension thereof, so that the fastening provided by the ring belt 46 and the pair of amphibious glasses 3 can be adjusted. It should be noted that the adjustment piece 47 shown in FIG. 4E is only for purposes of illustration, and practically any adjustment devices may be used in this invention.

Another kind of joint means for the fasteners is a non-detachable joint structure. As an example, the fasteners 36 adhere the hook structures 39 to the second end portions 38 of the temples 35 respectively. However, such an adhesion means does not allow for change in the position of the fasteners on the temples.

According to the above descriptions, the pair of amphibious glasses 3 of this invention comprises a temple assembly 34 that provides reinforced fixation, so that the tension can be adjusted depending on the personal needs to satisfy the needs for use in both water sports and land sports. When the user is engaged in a land sport, the pair of amphibious glasses 3 not only serves as a pair of sunglasses to shield off wind, light and rain, but may also be used as an industrial safety goggle at hazardous sites due to the eye protection function provided by the skirt 33. On the other hand, when the user is engaged in a water sport, the pair of amphibious glasses 3 can function as a frog goggle to prevent incursion of water into the skirt. In particular, the pair of amphibious glasses 3 of this invention eliminates the inconveniences associated with the switching between the swimming goggles for water use and eyeglasses for land use and difficulties in storing and carrying them when the user changes between a water sport and a land sport.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A pair of amphibious glasses, comprising:
a lens assembly, including at least one lens;
a frame assembly, including a main body, the main body defining at least one frame, the at least one lens being adapted to be embedded in the at least one frame;
a skirt, being attached to one side of the frame assembly and extending outward from the side of the frame assembly, adapted to fit a user's face around the user's eyes; and
a temple assembly, including two temples and two fasteners,
wherein first end portions of the temples are respectively disposed on two end portions of the frame assembly and the fasteners are respectively disposed on second end portions of the temples opposite to the first end portion so as to firmly dispose the pair of amphibious glasses on the user's face.

2. The pair of amphibious glasses as claimed in claim 1, wherein each of the fasteners comprises a hook structure adapted to fit against the user's ear.

3. The pair of amphibious glasses as claimed in claim 2, wherein each of the fasteners further comprises a joint structure detachably disposed on one of the second end portions of the temples.

4. The pair of amphibious glasses as claimed in claim 3, wherein each of the joint structures is a tube and adapted to detachably sleeve the second end portion of each of the temples.

5. The pair of amphibious glasses as claimed in claim 4, wherein each of the tubes is an elastomer so as to slide along the second end portion of each of the temples to adjust a distance between the fastener and the frame assembly.

6. The pair of amphibious glasses as claimed in claim 2, wherein each of the fasteners further comprises a joint structure, the joint structure comprises a protruded screw, each of the temples further comprises a screw hole, and the protruded screw is adapted to screw into the screw hole.

7. The pair of amphibious glasses as claimed in claim 3, wherein each of the joint structures comprises a clip adapted to detachably clip to the second end portion of each of the temples so that the user can adjust a distance between the fastener and the frame assembly.

8. The pair of amphibious glasses as claimed in claim 2, wherein each of the fasteners further comprises a joint structure adhered to the second end portion of each of the temples.

9. The pair of amphibious glasses as claimed in claim 1, wherein each of the fasteners comprises a ring structure adapted to ring the user's ear.

10. The pair of amphibious glasses as claimed in claim 1, wherein the fasteners comprises a ring belt adapted to ring the user's head.

11. The pair of amphibious glasses as claimed in claim 10, wherein the ring belt further comprises an adjustable piece adapted to adjust the tension thereof.

12. The pair of amphibious glasses as claimed in claim 1, wherein the first end portions of the temples are pivotally disposed on the two end portions of the frame assembly respectively.

13. The pair of amphibious glasses as claimed in claim 1, wherein the skirt has a deformable soft portion.

14. The pair of amphibious glasses as claimed in claim 13, wherein the soft portion is made of materials selected from a group consisting of thermoplastic rubber (TPR), thermoplastic polyurethane (TPU), thermoplastic elastomer (TPE), polyurethane (PU), polyvinylchloride (PVC), silicone, nature rubber and their combination.

15. A temple assembly for use in a pair of eyeglasses, wherein the pair of eyeglasses includes a main body, and the temple assembly is connected to the two corresponding end portions of the main body, the temple assembly comprising:
two temples, each of the temples having a first end portion and a second end portion, the two first end portions being disposed respectively on the two corresponding end portions of the main body; and
two fasteners, disposed respectively on the second end portions of the two temples, so that the pair of eyeglasses can be disposed on the user's face firmly.

16. The temple assembly as claimed in claim 15, wherein each of the fasteners comprises a hook structure adapted to fit against the user's ear.

17. The temple assembly as claimed in claim 16, wherein each of the fasteners further comprises a joint structure detachably disposed on the second end portion of each of the temples.

18. The temple assembly as claimed in claim 17, wherein the joint structure is a tube and adapted to detachably sleeve at the second end portion of each of the temples.

19. The temple assembly as claimed in claim 18, wherein each of the tubes is an elastomer so as to slide along the second end portion of each of the temples to adjust a distance between the fastener and the frame assembly.

20. The temple assembly as claimed in claim 16, wherein each of the fasteners further comprises a joint structure, the joint structure comprises a protruded screw, each of the temples further comprises a screw hole, the protruded screw is adapted to screw into the screw hole.

21. The temple assembly as claimed in claim 17, wherein each of the joint structures comprises a clip adapted to detachably clip to the second end portion of each of the temples so that the user can adjust a distance between the fastener and the frame assembly.

22. The temple assembly as claimed in claim 16, wherein each of the fasteners is adhered to the second end portion of each of the temples.

23. The temple assembly as claimed in claim 15, wherein each of the fasteners comprises a ring structure adapted to ring the user's ear.

24. The temple assembly as claimed in claim 15, wherein the first end portions of the temples are pivotally disposed on the two end portions of the frame assembly respectively.

25. The temple assembly as claimed in claim 15, wherein the fastener comprises a ring belt adapted to ring the user's head.

26. The temple assembly as claimed in claim 25, wherein the ring belt comprises an adjustable piece adapted to adjust the tension thereof.
